(19) United States
(12) Patent Application Publication
(10) Pub. No.: US 2004/0161044 A1
(43) Pub. Date: Aug. 19, 2004

(54) Method and apparatus for communication using pulse decoding

(75) Inventors: Jurianto Joe, Singapore (SG); Kin Mun Lye, Singapore (SG)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The National University of Singapore, Singapore (SG)

(21) Appl. No.: 10/717,188

(22) Filed: Nov. 17, 2003

Related U.S. Application Data
(63) Continuation of application No. 09/429,519, filed on Oct. 28, 1999, now abandoned.

(51) Int. Cl. H04L 27/00

(52) U.S. Cl. 375/259

(57) ABSTRACT

A signal of any physical form corresponding to an information character of an encoding alphabet, is transmitted as an analog waveform defining a symbol, the waveform being cyclical at the symbol rate, to a communication channel and then the signal when received by a receiver is converted to groups of pulses separated by silences, wherein each group of pulses maps to a count corresponding to a character of the encoding alphabet. The groups of pulses are separated by silences of arbitrary duration which are greater than the time between individual pulses. The pulses have a pulse rate greater than the frequency of the symbol. The system permits but does not require communication of relatively narrow bandwidth signals.

### BACKGROUND OF THE INVENTION

This invention relates to communication between a transmitter and a receiver via a channel. It has application to telecommunications, recording, data storage, and control.

With the development of electronic technologies, it has now been determined that transmission of radio frequency signals at the frequency of modulation is both possible and practical over a broad spectrum, from subaudio frequencies to microwave frequencies. However, heretofore, there has not been a modulation and demodulation technology which takes advantage of this capability.

### SUMMARY OF THE INVENTION

According to the invention, a signal of any physical form corresponding to an information character of an encoding alphabet, is transmitted as an analog waveform defining a symbol, the waveform being cyclical at the symbol rate, to a communication channel and then the signal when received by a receiver is converted to groups of pulses separated by silences, wherein each group of pulses maps to a count corresponding to a character of the encoding alphabet. The groups of pulses are separated by silences of arbitrary duration which are greater than the time between individual pulses. The pulses have a pulse rate greater than the frequency of the symbol. The system permits but does not require communication of relatively narrow bandwidth signals.

The invention is a baseband modulation and direct demodulation method and related system. It has advantages in that it does not require fill characterization or extraction of the symbol by the receiver, so that simple detectors and decoders can be used. Furthermore, there is no need or concept of impressing information on a carrier or of carrier recovery. There is likewise no concept of frequency conversion nor detection in an intermediate frequency band.

The invention is applicable not only to electromagnetic transmission and reception, it can be used with any energy form, whether or not coherent.

The invention will be better understood by reference to the following detailed description in connection with the accompanying drawings.

### BRIEF DESCRIPTION OF THE DRAWINGS

FIG. 1 is a block diagram of a communication system according to the invention.

FIG. 2 exemplifies an arbitrary analog waveform used to represent a symbol.

FIG. 3 illustrates an example of the pulses corresponding to the portion of the waveform discussed in connection with FIG. 2.

FIG. 4 is a simplified schematic of a receiver in accordance with the invention.

### DESCRIPTION OF THE SPECIFIC EMBODIMENTS

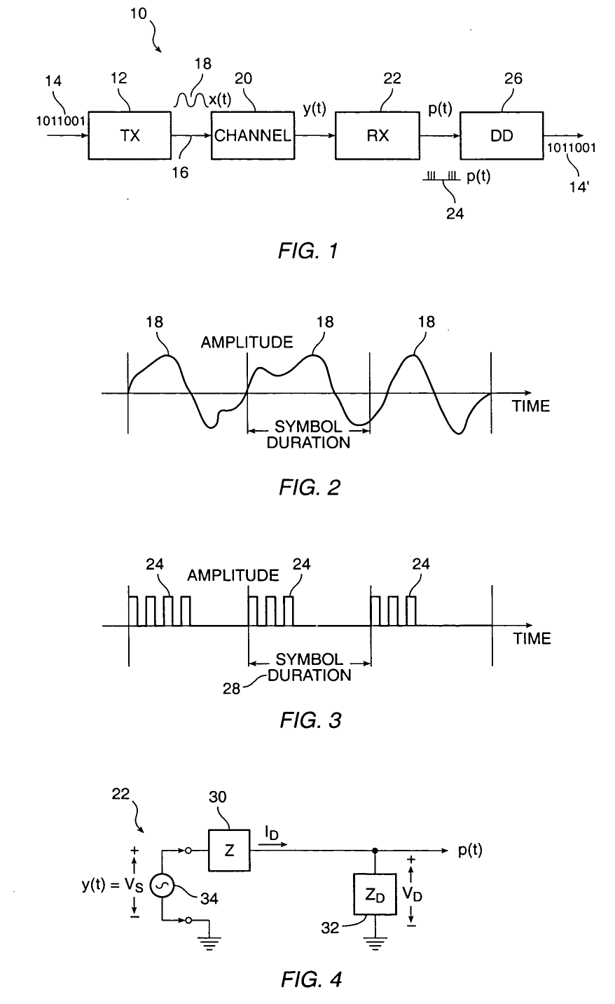

FIG. 1 is a block diagram of a communication system 10 according to the invention. The system 10 comprises a transmitter 12 and a receiver 22 coupled via a channel 20. The transmitter 12 receives a data stream 14 and transmits, via an output 16 an analog output waveform 18, represented by x(t) in the form of a sequence of symbols. The channel 20 is representative of all impairments to the transmitted signal x(t), including noise, between the transmitter 12 and the receiver 22. The channel 20 yields a received signal y(t) to the receiver 22. Hence, the transmission mapping function is given by:

y(t)=f(x(τ), t) (1)

The receiver 22 according to the invention produces an output in the form of groups of pulses or P(t), as hereinafter explained, that are applied to a decision device 26. The decision device 26 recovers a representation of the data stream 14 as a data stream 14′. This is done for example by counting pulses in each group and mapping the pulse counts of each group of pulses to the character established by the system character set.

Referring to FIG. 2, a sequence of symbols 18 is shown. The symbol 18 is an arbitrary analog waveform which may be a sinusoid, a ramp, a sawtooth, a square wave, an asymmetric waveform or a waveform having a shape selected to be optimized to the a priori characteristics of the channel 20, or any combination of such symbols. Each symbol is coded with information, for example by anything which affects the shape, including but not limited to amplitude, frequency, slope, phase and any combination thereof.

The symbol 18 is encoded by the transmitter 12. The transmitter maps each information character of a character set or alphabet of values to at least one shape for the symbol or symbols to be applied to the channel 20. There is typically a one-to-one correspondence between a character and a symbol. The simplest character set is the binary set “one” and “zero” or “true” and “false” but there is no limitation on the number of characters in the character set other than practical limitations imposed by natural laws about the number of bits per symbol. The more characters in a character set, the lower is the robustness for a given energy level in the presence of noise. The symbol rate is typically relatively slow with respect to the pulse train extracted therefrom.

Referring to FIG. 3, there is shown a representation of the groups 24 of pulses P(t) according to the invention. Each symbol maps to a single group of pulses 24. Thus for coding purposes, the rate of pulse generation must be greater than the symbol rate, and the duration of the silences between pulse groups must be greater than the expected rate of pulse generation. The duration of the silences plus the duration of the pulse train corresponds to duration 28 of a symbol. However, the silences are of arbitrary duration greater than the time between individual pulses. Thus each set of pulses can start and terminate at any time within the duration of a symbol, assuming as contemplated, decoding is in real time. The number of pulses in each pulse group can thus readily correspond to the information character represented by the symbol to which the pulse train corresponds. The waveform 18 may have many different mappings to a specific pulse count. This provides further robustness through coding redundancy.

Referring to FIG. 4, there is shown a basic circuit for the receiver 22. It comprises two elements Z 30 and Z_{D} 32. A signal source 34 represents the received signal y(t), which is here represented by a voltage Vs. The output is P(t). The signal source 34 applies the waveform to a first generalized normalized impedance element Z 30, which in turn applies the output across a second generalized impedance Z_{D} 32. The combination of the first and second generalized impedances Z 30 and Z_{D} 32 produce the pulse train output P(t). The generalized equations expressed in voltage terms and in current terms are given by:

$$\begin{matrix}{V}_{D} = {V}_{S} - Z \int {I}_{D} ⅆ t & ( 2 ) \\ ϵ \frac{ⅆ {I}_{D}}{ⅆ t} = {V}_{D} - Ψ ( {I}_{D} ) \\ OR & ( 3 ) \\ Z \frac{ⅆ {I}_{D}}{ⅆ t} = {V}_{S} - {V}_{D} & ( 4 ) \\ ϵ \frac{ⅆ {V}_{D}}{ⅆ t} = {I}_{D} - Ψ ( {V}_{D} ) & ( 5 )\end{matrix}$$

Equations 4 and 5 are duals of Equations 2 and 3. The equations describe a direct conversion of a wave shape in current or voltage to a pulse train upon proper choice of Ψ(.), where Ψ(.) is the transfer characteristic of the impedance element Z_{D}. ε is a small perturbative parameter.

This invention has been explained with reference to specific embodiments. Other embodiments will be evident to those of ordinary skill in the art. It is therefore not intended that this invention be limited except as indicated by the appended claims.

What is claimed is:

1. A method for communication between a transmitter and a receiver comprising:
generating an analog waveform corresponding to an information character of an encoding alphabet, said waveform defining a symbol, said waveform being cyclical at the symbol rate;
transmitting, from said transmitter to said receiver via a communications channel, a source signal characterized by said waveform matching said symbol, said communications channel having a channel characterization including noise, in order to yield a received signal; and
at said receiver, extracting from said received signal, information in the form of groups of pulses, said pulses being separated by silences of arbitrary duration greater than time between individual pulses, wherein the number of pulses in each pulse group corresponds to one of said information characters represented by said symbol, and wherein said pulses have a pulse rate greater than the frequency of said symbol.

2. The method of claim 1, wherein said analog waveform is selected from the group consisting of sinusoidal, ramp, asymmetric, sawtooth, square and channel-optimized symbol.

3. The method according to claim 1, wherein said analog waveform comprises mixtures of different waveform types, including time-varying channel-optimized symbols.

4. The method according to claim 1 wherein said at pulses have a peak to peak amplitude of at least zero to a maximum relative to non-oscillation.

5. A system for communication between a transmitter and a receiver comprising:
means in said transmitter for generating an analog waveform corresponding to an information character of an encoding alphabet, said waveform defining a symbol, said waveform being cyclical at the symbol rate and for conveying a source signal characterized by said waveform matching said symbol, said communications channel having a channel characterization including noise, in order to yield a received signal; and
means in said receiver for extracting, from said received signal, information in the form of groups of pulses, said pulses being separated by silences of arbitrary duration greater than time between individual pulses, wherein the number of pulses in each pulse group corresponds to one of said information characters represented by said symbol, and wherein said pulses have a pulse rate greater than the frequency of said symbol.

6. The system of claim 1, wherein said analog waveform is selected from the group consisting of sinusoidal, ramp, asymmetric, sawtooth, square and channel-optimized symbol.

7. The system according to claim 1, wherein said analog waveform comprises mixtures of different waveform types, including time-varying channel-optimized symbols.

8. The method according to claim 1 wherein said pulses have a peak to peak amplitude of at least zero to a maximum relative to non-oscillation.
